(19) United States
(12) Patent Application Publication
(10) Pub. No.: US 2016/0193775 A1
(43) Pub. Date: Jul. 7, 2016

(54) DEVICE AND METHOD FOR PRODUCING STERILE CONTAINERS

(71) Applicant: KHS CORPOPLAST GMBH, Hamburg (DE)

(72) Inventors: Frank LEWIN, Tangstedt (DE); Thomas HEROLD, Ahrensburg (DE); Jan Fabian MEYER, Hamburg (DE); Martin GERHARDS, Hamburg (DE); Dieter KLATT, Hamburg (DE); Rolf BAUMGARTE, Ahrensburg (DE)

(21) Appl. No.: 14/911,649

(22) PCT Filed: Aug. 13, 2014
(86) PCT No.: PCT/EP2014/002219

§ 371 Date: Feb. 11, 2016

(30) Foreign Application Priority Data
Aug. 19, 2013 (DE) 10 2013 013 589.3

(51) Int. Cl. B29C 49/42; B29C 49/46

(52) U.S. Cl. CPC B29C 49/4252; B29C 49/46; B29C 2049/4682; B29K 2105/258

(57) ABSTRACT

A method and device for producing blow-molded containers which are sterile at least in some areas. A preform made of a thermoplastic material is first heated and then supplied with a pressurized fluid, and the preform is supplied with a sterilizing radiation at least in some areas. A radiation source for the sterilizing radiation is arranged at a distance to the preform, and a supplying device is moved into the preform. The supplying device conducts the sterilizing radiation from the radiation source into the preform and emits the sterilizing radiation onto the preform inner wall.

The invention relates to a method for producing blow-molded containers which are sterile in at least some areas, in which method a preform from a thermoplastic material is initially heated and then is impinged with a pressurized fluid, and in which method a radiation source impinges the preform with sterilization radiation.

Moreover, the invention relates to a device for producing blow-molded containers which are sterile in at least some areas, which device has a radiation source for impinging at least a part of a preform with sterilizing radiation, and which device is provided with a heating section for temperature controlling the preforms and a blowing installation for blow-molding the preforms to form the containers.

Manufacturing of sterile blow-molded containers is typically performed in that these containers after blow-molding and prior to filling are sterilized using hydrogen peroxide or other chemicals. It is likewise already known for the preforms, in particular the area of the internal surface of these preforms, which in blow-molding of the containers are used as the primary product, to be sterilized.

In the case of container molding by way of the effect of blowing pressure, preforms from a thermoplastic material, for example preforms from PET (polyethylene terephthalate) within a blowing machine are supplied to various processing stations. A blowing machine of this type typically has a heating installation and a blowing installation, in the region whereof the preform which prior thereto has been temperature controlled is expanded by way of biaxial orientation to form a container. Expansion is performed with the aid of compressed air which is directed into the preform to be expanded. The process-technological sequence of expanding the preform in such a manner is set forth in DE-OS 43 40 291.

The in-principle construction of a blowing station for molding containers is described in DE-OS 42 12 583. Possibilities for temperature controlling the preforms are set forth in DE-OS 23 52 926.

Within the device for blow molding, the preforms and the blown containers may be conveyed with the aid of various handling installations. The use of conveying mandrels onto which the preforms are push-fitted has proven particularly successful. However, the preforms may also be handled using other carrier installations. The use of gripping tongs for handling preforms, and the use of expanding mandrels which for mounting are introducible into a mouth area of the preform, inter alia are likewise available constructions.

Handling containers using transfer wheels in an arrangement with the transfer wheel between a blowing wheel and a delivery section is described in DE-OS 199 06 438, for example.

Handling of the preforms as has already been set forth is performed, on the one hand, in the so-called dual-stage methods in which the preforms are initially manufactured in an injection-molding method, are thereafter temporarily stored and are only later conditioned in terms of temperature and blown to form a container. On the other hand, an application is performed in the so-called single-stage methods in which the preforms are suitably temperature controlled and subsequently blown immediately after having been manufactured by injection-molding technology and having sufficiently solidified.

In terms of the blowing stations used, various embodiments are known. In the case of blowing stations which are disposed on rotating conveying wheels, book-like unfolding capability of the mold carriers may often be encountered. However, it is also possible for mold carriers which are mutually displaceable or guided in another manner to be employed. In the case of locationally fixed blowing stations which are in particular suitable for receiving a plurality of cavities for container molding, plates which are disposed so as to be mutually parallel are typically used as mold carriers.

In terms of sterilizing preforms, various methods and devices which, however, all have method-specific disadvantages, are already known from the prior art, said disadvantages impeding reliable sterilization of the preforms at simultaneously high output rates.

Sterilizing hot preforms using a hot gaseous sterilization means is described in EP-A 1 086 019, for example. Separate treatment stations which are sequentially disposed are used, namely a first heating module, a sterilizing module, and a second heating module. Here, the temperature-related behavior of the preform during the sterilizing procedure and uncontrolled leakage of the sterilization means from the preform within the heating unit are disadvantageous here.

A method in which a gaseous sterilization means is directed into a cold preform and condenses therein prior to heating is described in EP-A 1 896 245. Ensuring overall formation of condensate on the entire internal face of the preform is problematic here, since the hot sterilization means streaming in increases the internal wall temperature of the preform. Moreover, here too the sterilization means after evaporation in the region of the heating unit leaks in an uncontrolled manner within the heating unit from the preform.

The arrangement of a sterilizing installation between a heating unit and the blowing module is described in WO 2010/020530 A1. In this method, the amount of sterilization means to be applied in the region of the blowing module is foreseeable only with great difficulty. Moreover, the amount of sterilization means being released into the environment is uncontrollable and corresponding contamination is not excluded.

The use of UV emitters for sterilizing tasks is generally known from DE 295 03 830 U1, for example. A space which is enclosed by a protective housing is to be de-germinated by irradiation using UV light. This document does not disclose de-germinating preforms or containers.

DE 10 2008 038 143 A1 discloses that UV radiation emitters are employable for sterilizing the external wall of preforms. Sterilizing in the interior of the preforms is not achievable therewith, since the emitted UV radiation is not capable of penetrating the plastics material of the preform.

The document of the generic type DE 10 2007 017 938 B4 discloses the use of radiation emitters for sterilizing the internal surfaces of performs as well. For this purpose, a sterilizing probe which carries a radiation emitter is introduced into the preform to be sterilized. The documents of the generic type WO2010/012915 A1 and EP 2 138 298 A2, in which for internally sterilizing a preform a radiation source is likewise introduced into the mouth of the preform, also show comparable prior art. It is stated in the last-mentioned document that a plurality of sterilizing installations are to be provided, namely at least one ahead of the installation in which the preforms are formed to containers, and at least one thereafter. It is seen to be disadvantageous in particular in the last-mentioned prior art that high complexity in terms of apparatuses is required. Also, on account of the tight conditions in a preform, radiation emitters of small construction size and thus having low intensity are only usable. Finally, it is seen as disadvantageous that in the case of technical problems relating to the radiation emitter that probe which carries the emitter and is to be introduced into the preform has to be replaced, and that sterilizing is not possible until replacement has taken place.

It is thus the object of the present invention to state a method by way of which sufficient sterility of the preforms may be guaranteed in a simple manner. A further object of the present invention is to state a respective device by way of which the method according to the invention is capable of being carried out.

These objects are achieved by a method as claimed in claim 1 and by a device as claimed in claim 14.

According to the method according to the invention, at least one radiation source for the sterilizing radiation is disposed so as to be spaced apart from the preform. An infeeding installation routes the sterilizing radiation from the radiation source into the preform and radiates said sterilizing radiation onto the perform internal wall. The infeeding installation is introduced for this purpose into the preform.

According to the device according to the invention, at least one radiation source for the sterilizing radiation is disposed so as to be spaced apart from the preforms. The sterilizing installation has an infeeding installation which is introducible into a preform. The infeeding installation is furthermore configured so as to route the sterilizing radiation from the radiation source into the interior of the preform and onto the preform internal wall.

Both the method according to the invention as well as the device according to the invention enable the use of a radiation source having high radiation intensity which is sufficient for the sterilizing task, without the dimensional limitation of the prior art setting limits to the emitters, since according to the invention the radiation source need not be introduced into the preform. Instead, means which route the sterilizing radiation from the source into the preform and radiate said radiation onto the internal wall are provided. The invention relates in particular to UV radiation sources in which these means for routing and radiating the UV radiation in terms of construction may be configured in a particularly simple manner, particularly in comparison with other radiation sources such as, for example, electron beam emitters or other emitters which emit high-energy radiation.

Further advantageous design embodiments of the method and of the device are stated in the dependent claims.

Preferably, the radiation source conjointly moves with the preform. To this end, said radiation source may be disposed on the conveying means which also convey the preform, for example. This has the advantage that continuous irradiating of the preform is possible over a prolonged period of time, namely over the period of time of the conveyance of the preform by the conveying means. Such conveying means may be transfer wheels, for example. At least one conjointly rotating radiation source may be disposed on each conveying space of the transfer wheel.

Alternatively thereto, the at least one radiation source may also be disposed so as to be stationary, the preform moving past the radiation source. This may be advantageous, for example, when irradiating is to be performed in an area of the blowing machine in which the conveying means are not suitable for carrying and moving a radiation source in addition to the preform, or when tight spatial conditions prevail. The stationary arrangement has the further advantage that the supply of the radiation source with electricity, for example, is simplified. It is disadvantageous that the residence time for radiating is typically shorter than in the case of conjointly moved emitters. However, this may be compensated for by way of a higher radiation output and by disposing a plurality of emitters which are placed behind one another in the conveying direction.

The emitter may be pulse-driven, for example, in order for radiation pulses of particularly high intensity to be emitted. In the case of emitters which are disposed so as to be stationary, synchronizing means would have to be advantageously provided, so as to trigger the pulse at points in time at which a preform is guided past the radiation source and reaches a position which is favorable in terms of irradiation.

Advantageously, the infeeding installation at least in areas is produced from a material which conducts UV radiation, in particular from a quartz glass. On account thereof, this area may serve in routing and radiating the UV radiation. Suitable glass varieties are known in the prior art, for example from DE 10 2009 015 088 A1.

The sterilizing effect of radiation decreases as distance increases. Furthermore, a homogeneous sterilizing effect is desirable. Therefore, the external contour of the infeeding installation is preferably shaped to follow the internal contour of the preform to be sterilized, so as to configure a narrow and in particular equidistant gap between the infeeding installation and the preform in the introduced state.

The sterilizing effect may be supported in that the infeeding installation has an internal duct through which ionized air and/or a chemical sterilizing means, in particular hydrogen peroxide, in a flowable aggregate state is routed into the preform from a source which lies outside the preform. Optionally, a containment and a vacuum unit could be provided in that process area of the blowing machine into which a chemical sterilizing means or ionized air is infed through the internal duct. In the case of the use of UV emitters it is advantageous that the preforms are purged with nitrogen via the internal duct, so as to remove oxygen from the preforms, since ozone may be formed when irradiating is performed at wavelengths of less than approx. 200 nm.

A preferred potential for the arrangement of the sterilizing installation is achievable in that the infeeding installation configures the stretching rod. On account thereof, sterilizing would be performed in the blowing station and thus at a late point in time of the blow-molding process, such that the risk of renewed infestation with germs is reduced.

An alternative or cumulative potential for the arrangement having preferred properties is presented in that infeeding of the sterilizing radiation into the interior of the preform is performed so as to be temporally prior to heating the preform to the blow-molding temperature, in particular is performed on an entry star wheel ahead of the oven or on at least one conveying star wheel which is upstream of the entry star wheel. This opens up the potential for retrofitting existing blowing machines and permits a modular construction. On account thereof, it is also possible for the residence time for sterilizing radiating to be extended, for example by using a conveying star wheel having a longer revolving time.

Radiating the radiation could for example be performed only at the tip end of the infeeding installation. Then the internal walls would only be irradiated while the infeeding installation is being deployed or retracted, while the base area of the preform is exposed to radiation for a longer time. Radiation which is performed so as to be only in a lateral direction would also lead to non-uniform irradiation of the interior of the preform. With a view to homogeneous irradiation of the preform it is thus preferable that the infeeding installation radiates the sterilizing radiation both at the tip end in the direction of the closed end of the preform, as well as laterally in the direction toward the side walls of the preform, in particular along a substantial length of the area which is deployed into the preform.

The above-described method and the above-described device serve only for irradiating the internal walls of the preform. In order for further critical areas to be sterilized, a further radiation source is advantageously disposed so as to be lateral to the neck area of the preform, irradiating the neck area with sterilizing radiation. This here is preferably a UV emitter.

Suitable UV emitters are known in the prior art, for example UV LEDs, low-pressure amalgam lamps, (low pressure, medium pressure, high pressure and maximum pressure) mercury vapor lamps, excimer lasers, and diode lasers.

Exemplary embodiments of the invention are illustrated in a schematic manner in the drawings in which:

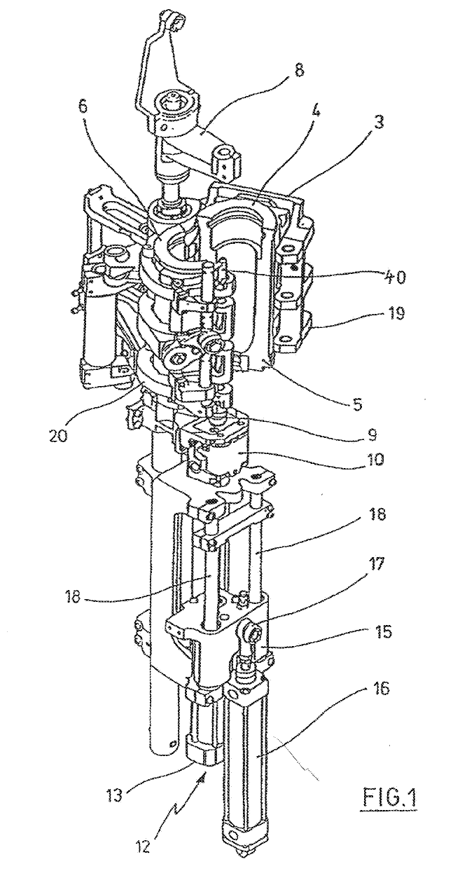

FIG. 1 shows a perspective illustration of a blowing station for producing containers from preforms;

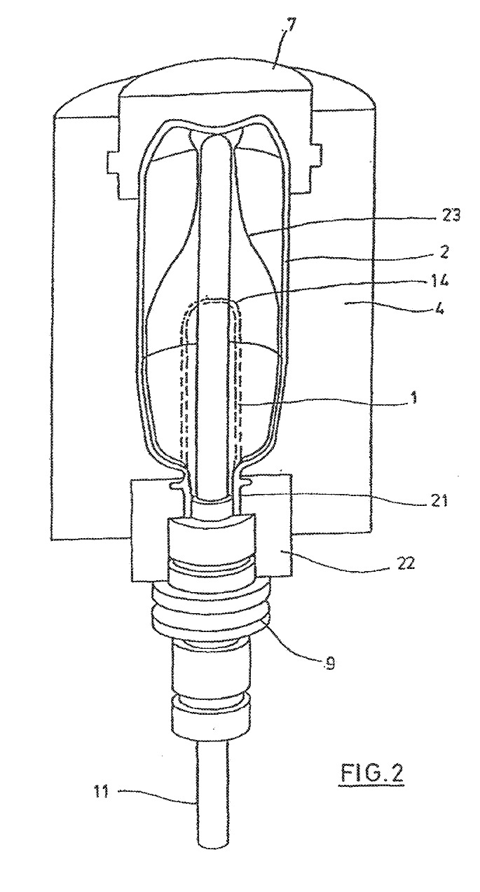

FIG. 2 shows a longitudinal section through a blow mold in which a preform is stretched and expanded;

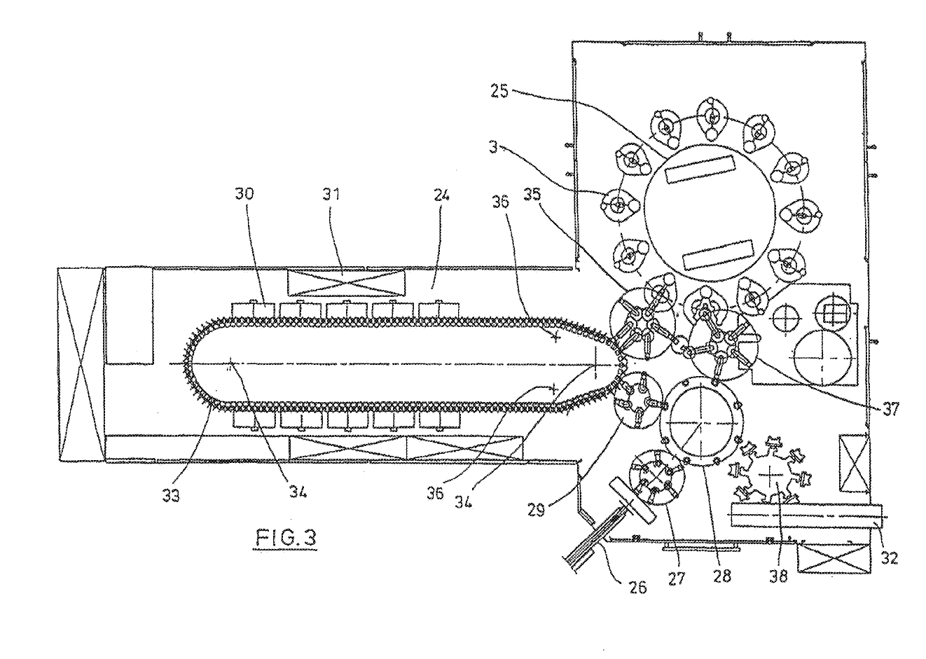

FIG. 3 shows a diagram to visualize an in-principle construction of a device for blow-molding containers;

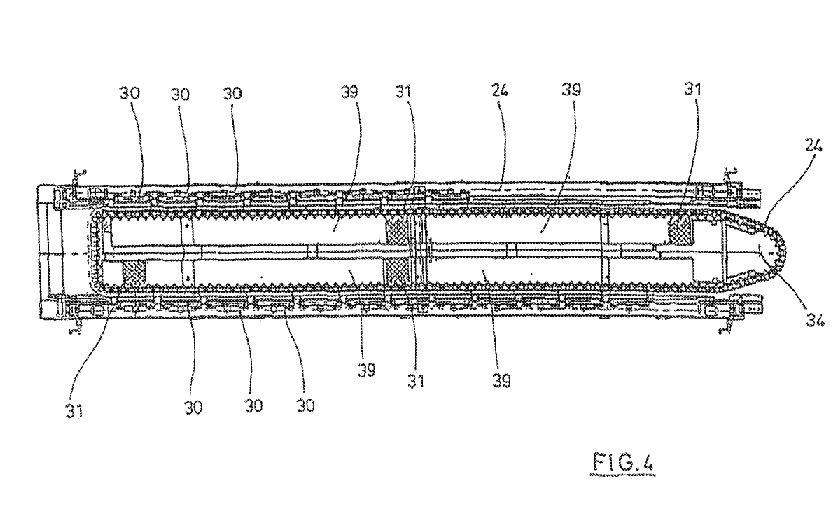

FIG. 4 shows a modified heating section having an increased heating capacity;

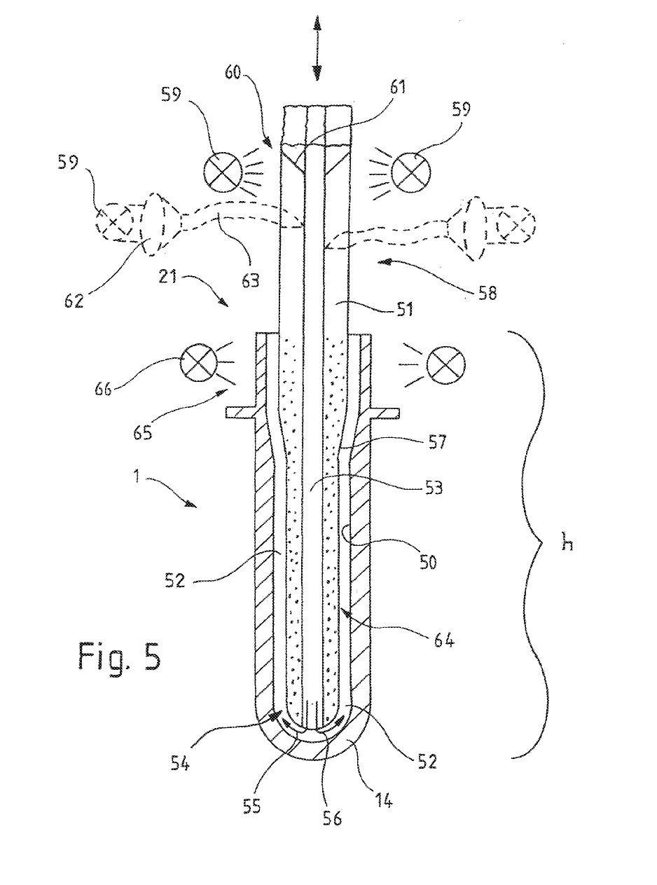

FIG. 5 shows a preform having a radiation applicator deployed thereinto and having a plurality of radiation sources, in a schematic sectional illustration;

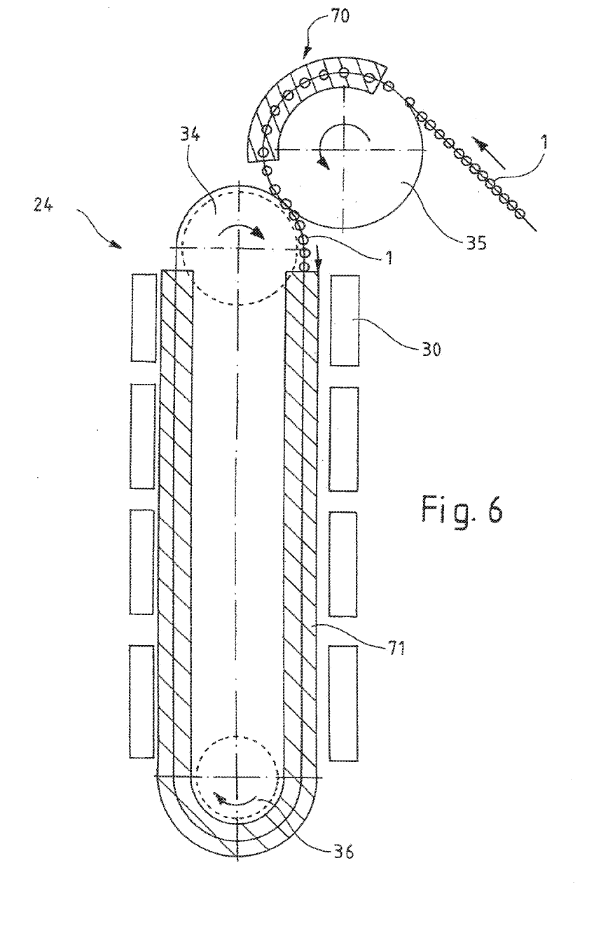

FIG. 6 shows the entry area and the heating section of a blow-molding machine having a sterilizing installation, in an in-principle plan view;

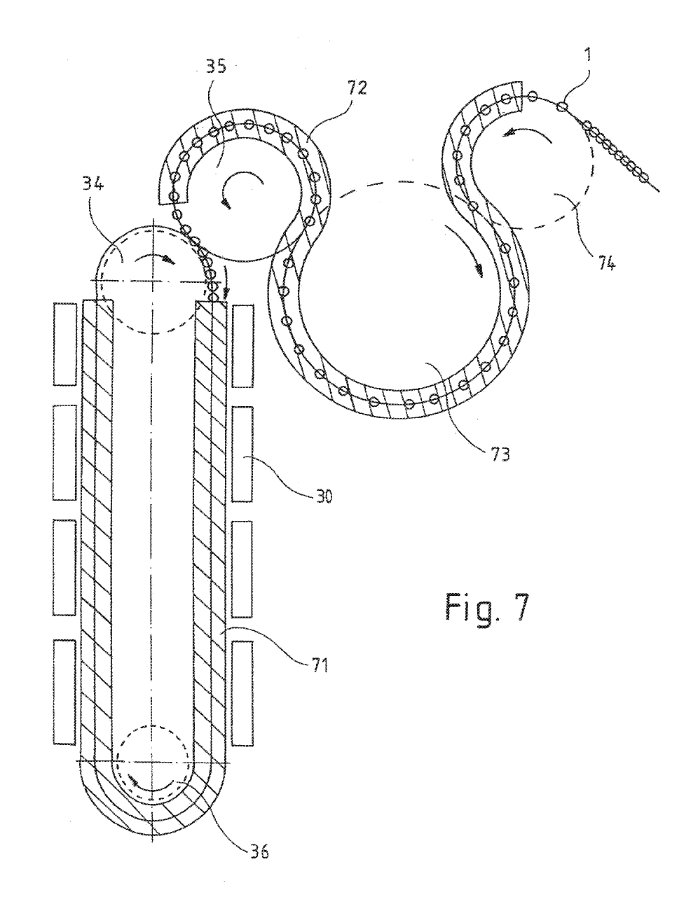

FIG. 7 shows in an illustration according to FIG. 6 an embodiment of an entry area which as compared with the former is modified; and

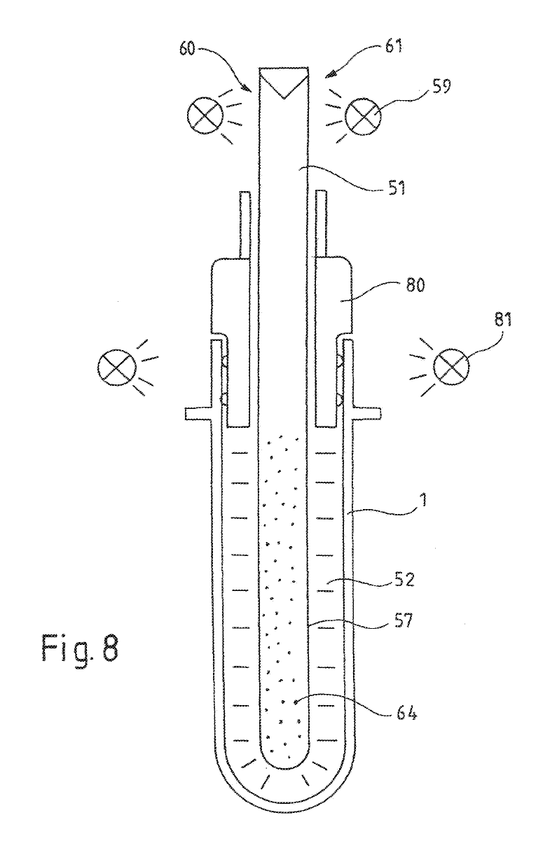

FIG. 8 shows in an illustration according to FIG. 5 a further exemplary embodiment of a radiation applicator.

The in-principle construction of a device for forming preforms 1 into containers 2 is illustrated in FIGS. 1 and 2.

The device for molding the container 2 is substantially composed of a blowing station 3 which is provided with a blow mold 4 into which a preform 1 is insertable. The preform 1 may be an injection-molded part made from polyethylene terephthalate. In order to enable insertion of the preform 1 into the blow mold 4, and in order to enable removal of the finished container 2, the blow mold 4 is composed of two mold halves 5, 6, and of a base part 7 which is positionable by a lifting device 8. The preform 1 in the area of the blowing station 3 may be held by a conveying mandrel 9 which together with the preform 1 passes through a plurality of treatment stations within the device. However, it is also possible for the preform 1 to be inserted directly into the blow mold 4 for example by way of tongs or other handling means.

In order for a compressed-air supply line to be enabled, a connector piston 10 which supplies compressed air to the preform 1 and at the same time performs sealing toward the conveying mandrel 9 is disposed below the conveying mandrel 9. However, in the case of a modified construction it is in principle also conceivable that fixed compressed-air supply lines are used.

Stretching of the preform 1 is performed with the aid of a stretching rod 11 which is positioned by a cylinder 12. However, in principle it is also conceivable for mechanical positioning of the stretching rod 11 to be carried out by curved segments which are impinged by tracking rollers. The use of curved segments is expedient in particular when a plurality of blowing stations 3 are disposed on a rotating blowing wheel. Use of cylinders 12 is expedient when blowing stations 3 which are disposed in a locationally fixed manner are provided.

In the embodiment illustrated in FIG. 1 the stretching system is configured in such a manner that a tandem arrangement of two cylinders 12 is provided. Prior to commencement of the stretching procedure per se, the stretching rod 11 is initially moved by a primary cylinder 13 into the area of a base 14 of the preform 1. During the stretching procedure per se the primary cylinder 13 having the extended stretching rod, together with a slider 15 which supports the primary cylinder 13, is positioned by a secondary cylinder 16 or by way of a cam control unit. In particular, it is contemplated that the secondary cylinder 16 is employed in a cam-controlled manner such that a current stretching position is predefined by a guide roller 17 which slides along a curved track while the stretching procedure is carried out. The guide roller 17 is urged against the guide track by the secondary cylinder 16. The slider 15 slides along two guide elements 18. After the mold halves 5, 6 which are disposed in the area of supports 19, 20 have been closed, mutual interlocking of the supports 19, 20 with the aid of an interlocking installation 40 is performed.

In order for a mouth portion 21 of the preform 1 to be adapted to various shapes, the use of separate threaded inserts 22 is provided according to FIG. 2 in the area of the blow mold 4.

In addition to the blown container 2, FIG. 2 also shows the preform 1 having dashed lines and in a schematic manner a container bubble 23 under formation.

FIG. 3 shows the in-principle construction of a blowing machine which is provided with a heating section 24 as well as a rotating blowing wheel 25. Proceeding from a preform infeed 26, the preforms 1 are conveyed into the area of the heating section 24 by transfer wheels 27, 28, 29. Heating radiators 30 and blowers 31 are disposed along the heating section 24, so as to temperature control the preforms 1. After sufficient temperature control of the preforms 1, the latter are transferred to the blowing wheel 25, the blowing stations 3 being disposed in the area thereof. The blown finished containers 2 are supplied to a delivery section 32 by further transfer wheels.

In order to be able to form a preform 1 into a container 2 in such a manner that the container 2 has material properties which guarantee a prolonged shelf life of foodstuffs, in particular beverages, which are filled into the container 2, special method steps must be adhered to when heating and orienting the preforms 1. Moreover, advantageous effects may be achieved by adhering to special dimensional rules.

Various plastics may be used for the thermoplastic material. PET, PEN, or PP are employable, for example.

Expanding the preform 1 during the orientation procedure is performed by supplying compressed air. The compressed air supply is subdivided into a pre-blowing phase in which gas, for example compressed air, is supplied at a low pressure level, and into a subsequent main blowing phase in which gas is supplied at a comparatively high pressure level. During the pre-blowing phase, compressed air at a pressure in the range of 10 bar to 25 bar is typically used, and during the main blowing phase, compressed air at a pressure in the range of 25 bar to 40 bar is supplied.

It can likewise be seen in FIG. 3 that the heating section 24 in the embodiment illustrated is configured by a plurality of revolving conveying elements 33 which are strung together in a chain-like fashion and are guided along deflection wheels 34. In particular, it is contemplated that a substantially rectangular basic contour is defined by the chain-like arrangement. In the case of the embodiment illustrated, a single deflection wheel 34 which is of comparatively large size is used in the area of that extent of the heating section 24 that faces the transfer wheel 29 and an infeed wheel 35, and two deflection wheels 36 which are of comparatively small size are used in the area of adjacent deflections. However, other guides are also conceivable in principle.

In order for as tight a mutual arrangement of the transfer wheel 29 and of the infeed wheel 35 as possible to be enabled, the arrangement illustrated has proven particularly expedient, since three deflection wheels 34, 36 are positioned in the area of the respective extent of the heating section 24, specifically in each case the comparatively small deflection wheels 36 in the area of the transition toward the linear profiles of the heating section 24, and the comparatively large deflection wheel 34 in the immediate transfer area to the transfer wheel 29 and to the infeed wheel 35. As an alternative to the use of chain-like conveying elements 33, it is also possible for a rotating heating wheel to be used, for example.

After blowing of the containers 2 has been completed, the latter are guided out of the area of the blowing stations 3 by a retrieval wheel 37 and by way of the transfer wheel 28 and of a delivery wheel 38 are conveyed to the delivery section 32.

On account of the higher number of heating radiators 30, a larger amount of preforms 1 per unit of time may be temperature controlled in the modified heating section 24 illustrated in FIG. 4. The blowers 31 here direct cooling air into the area of cooling air ducts 39 which in each case lie opposite the assigned heating radiators 30 and discharge the cooling air via outflow openings. On account of the arrangement of the outflow directions, a streaming direction for the cooling air that is substantially transverse to a conveying direction of the preforms 1 is implemented. The cooling air ducts 39 in the area of those surfaces that lie opposite the heating radiators 30 may provide reflectors for the radiation of heat; it is likewise possible for cooling of the heating radiators 30 to be implemented by way of the dissipated cooling air.

An applicator 51 for sterilizing the internal wall 50 in the mouth area 21 has been introduced into the preform 1 shown in FIG. 5. The state in which the applicator 51 has been completely deployed into the preform 1 is illustrated. The lifting means for carrying out the movement of the applicator 51 in relation to the preform 1 are not illustrated. For example, these lifting means may be cam-controlled means or linear actuators, for example actuators which are driven by electric motive power or by hydraulics.

The internal wall 50 of the preform 1 has a contour which follows the external contour of the applicator 51 in the shown state, while configuring a gap 52. The applicator 51 has an internal duct 53 which runs from the upper end (not illustrated), on which the lifting means (not illustrated) could also engage, to the free end which by way of the rounded tip 54 lies opposite the base area 14 of the preform 1, spaced apart therefrom by a gap width. This gap width in the example shown is substantially constant along the preform height h and here is chosen to be so slight that the radiation which is radiated by the applicator 51 impacts by way of a radiation density which is still high, on the one hand. On the other hand, however, the gap width is chosen to be so large that ionized gas 55 or a chemical sterilizing means 56 which exits from the internal duct 53 at the rounded tip of the applicator 51 still encounters a suitable available flow cross section so as to stream through between the preform internal wall 50 and the applicator external wall 57.

In the exemplary embodiment shown the applicator 51 is made entirely from a quartz glass. UV emitters 59 which in particular emit radiation in a wavelength range which is suitable for sterilizing, for example in the range of 180 to 300 nm, either in a narrow band or in a wide band, are disposed as radiation sources above the mouth 21 of the preform 1 and laterally adjacent to the applicator area 58 which protrudes from the preform 1. It is seen as being optimal for the radiation to be intense in the range of 220 nm and/or 265 nm. The UV radiation is radiated in the direction toward a launching area 60 of the applicator 51 and there is launched by a launching installation 61 and directed toward the tip 54. This launching installation 61 may be a mirror surface having a suitable inclination, or be a prism arrangement.

An alternative launching installation, which is composed of a converging lens 62 which bundles the radiated UV light onto the entry end of an optical fiber 63, is illustrated by a chain line. The optical fiber 63 (or else a fiber bundle) runs up to the applicator 51 and is routed into the launching area 60 in a lateral manner within the latter. The UV light is radiated by way of the exit end of the optical fiber 63 and in the applicator 51 is routed onward in the direction of the tip 54 of the latter.

In order for all wall areas to be reliably impinged with sterilizing radiation in a uniform manner, irradiation of the internal wall 50 of the preform 1 which is as homogeneous as possible along the entire height h is desirable. To this end, the applicator 51 in that area that is introduced into the preform 1, that is to say the radiating area, is provided with means 64 which support uniform radiation. Such means may be composed of a facet cut of the surface 57 or of reflector bodies which are embedded in the applicator material, for example. The radiation intensity may be improved in that the wall of the duct 53 is configured so as to be reflective.

Sterilizing of not only the internal wall 50 of the preform 1 is worthwhile in order for the desired sterile filling of beverages, for example, into the finished blow-molded container 2 to be achieved. The threaded area 65 should also be kept sterile. To this end, lateral radiation sources 66, for example electron beam emitters or UV emitters, are disposed level with the threaded area 65 and are directed toward the latter in the exemplary embodiment of FIG. 5.

There are various potentials in order for the above-described sterilizing installation, for example, to be disposed in the blowing machine. The preferred arrangement according to the invention is illustrated in FIGS. 6 and 7.

FIG. 6 shows the entry area of a blowing machine, having a heating section 24. The sterilizing device 70 in the exemplary embodiment illustrated is disposed on the infeed wheel 35. Disposed so as to be stationary on a part-circumference of the infeed wheel 35 are radiation sources (not illustrated) which impinge preforms 1 which run through this effective angular area of the infeed wheel 35 with UV radiation, for example. After running through this effective angular area, the preforms 1 are transferred from the infeed wheel 35 into the heating section 24 and there guided past heating boxes 30 and brought to the temperature required for blow molding. Alternatively or additionally, a further sterilizing device 71 which in an analogous manner has emitters (not illustrated) which impinge preforms 1 running through the heating section 24 with sterilizing radiation is provided also along the heating section 24. The preforms 1 which are supplied to the infeed wheel 35 in a non-sterile manner are in this way sterilized after passing through the effective angular area of the infeed wheel 35 and/or after passing through the sterilizing device 71 which is disposed in the heating section 24, and are thereafter conveyed to the blowing station 3. The sterilizing devices 70 and 71 which cover separate areas may also directly adjoin one another and form one overall sterilizing device.

The arrangement of the sterilizing device 70 on the infeed wheel 35 enables in particular that the emitters are disposed so as to conjointly run with the preforms 1. A dedicated UV emitter which is attached to the infeed wheel 35 in a locationally fixed manner may be assigned to each receptacle pocket of the infeed wheel 35, for example. The UV emitter would act on the preform 1 during the conjoint conveying time of the preforms 1 on the infeed wheel 35. The residence time may be increased on account of the additional arrangement or of the alternative arrangement of a sterilizing device 71 on the heating section 24. The UV emitters of the sterilizing device 71 could be disposed so as to be stationary, for example.

In the exemplary embodiment illustrated in FIG. 7 further transfer wheels 73 and 74 are disposed ahead of the infeed wheel 35 in the moving direction of the preforms 1. In comparison with the infeed wheel 35 the transfer wheel 73 has an increased diameter, so as to enable a larger effective angular area and a longer residence time of the sterilizing device 72. Here too, the radiation sources of the sterilizing device 72 may be selectively configured so as to be conjointly running or so as to be stationary. As is already the case in the exemplary embodiment of FIG. 6, a further sterilizing device 71 may alternatively or cumulatively be provided in the area of the heating section 24.

FIG. 8 shows an alternative exemplary embodiment of an applicator 51. Differing from the exemplary embodiment of FIG. 5, a conveying mandrel 80 which, as is known in principle from the prior art, carries the preform 1 in a clamping manner and guides the latter through the heating section 24, for example, is located in the mouth area 21 of the preform 1. The applicator 51 is guided through a central bore 81 of the mandrel 80 into the interior of the preform and in this deployment area radiates sterilizing radiation which in the launching area 60, which is outside the preform 1, is launched into the applicator 51, for example by way of lateral irradiation onto mirror faces or by other launching installations 61. To this end, radiation emitting emitters 59 are provided on the launching area 60.

In a manner not illustrated and as has been described in FIG. 5, this applicator 51 could have a duct for routing through ionized air or a chemical sterilizing means. Since the mouth area 21 and the threaded area 65 of the preform 1 are covered from the inside by the conveying mandrel 80, radiation sources 81, for example electron beam emitters, which impinge the threaded area 65 with sterilizing radiation from the outside, are disposed outside the preform 1, so as to be level with the threaded area 65. However, these emitters 81 may also be configured as UV emitters, wherein UV radiation then only sterilizes the external threaded area 65, while electron beams may penetrate the preform 1 and thus likewise sterilize that part of the internal wall 50 of the preform 1 that is level with the threaded area 65.

1-25. (canceled)

26. A method for producing blow-molded containers which are sterile in at least some areas, the method comprising the steps of initially heating a preform of a thermoplastic material; impinging the preform with a pressurized fluid; impinging the preform with sterilizing radiation in at least some areas, wherein a radiation source for the sterilizing radiation is disposed so as to be spaced apart from the preform; and introducing an infeeding installation, which routes the sterilizing radiation from the radiation source into the preform and radiates said sterilizing radiation onto a preform internal wall, into the preform.

27. The method as claimed in claim 26, wherein the radiation source moves with the preform.

28. The method as claimed in claim 26, wherein the radiation source is disposed so as to be stationary, the preform moving past the radiation source.

29. The method as claimed in claim 26, wherein the radiation source is a UV emitter.

30. The method as claimed in claim 29, wherein the infeeding installation at least in areas is made of a material that conducts UV radiation.

31. The method as claimed in claim 30, wherein the material is a quartz glass.

32. The method as claimed in claim 26, wherein the infeeding installation has an external contour that follows an internal contour of the preform to be sterilized, the method including maintaining a narrow gap between the infeeding installation and the preform when the infeeding installation is in the preform.

33. The method as claimed in claim 32, wherein the gap is equidistant.

34. The method as claimed in claim 26, wherein the infeeding installation has an internal duct through which ionized air and/or nitrogen and/or a chemical sterilizing agent, in a flowable aggregate state is routed into the preform from a source that lies outside the preform.

35. The method as claimed in claim 34, wherein the chemical sterilizing agent is hydrogen peroxide.

36. The method as claimed in claim 26, wherein the infeeding installation forms a stretching rod.

37. The method as claimed in claim 26, wherein infeeding of the sterilizing radiation into the interior of the preform is performed so as to be temporally prior to heating the preform to a blow-molding temperature.

38. The method as claimed in claim 37, including performing the infeeding of the sterilizing radiation on an entry star wheel ahead of an oven and/or on at least one conveying star wheel upstream of the entry star wheel and which has a longer revolving time than the entry star wheel.

39. The method as claimed in claim 26, wherein the infeeding installation radiates the sterilizing radiation at a tip end in a direction of a closed end of the preform and/or laterally in a direction toward side walls of the preform along a substantial length of a region of the infeeding installation deployed into the preform.

40. The method as claimed in claim 26, including arranging a further radiation source so as to be lateral to a neck area of the preform and so as to irradicate the neck area of the preform with sterilizing radiation.

41. The method as claimed in claim 40, wherein the further radiation source is a UV emitter.

42. The method as claimed in claim 26, including guiding the infeeding installation for introduction into the preform through a carrier installation that carries the preform through an oven, wherein the carrier installation is a conveying mandrel.

43. A device for producing blow-molded containers which are sterile in at least some areas, the device comprising: a sterilizing installation having at least one radiation source for impinging at least a part of a preform with sterilizing radiation; a heating section for temperature controlling the preforms at a blow-molding temperature; and a blowing installation for blow-molding the preforms to form the containers, wherein the radiation source for the sterilizing radiation is disposed so as to be spaced apart from the preforms, wherein the sterilizing installation includes an infeeding installation that is deployable into an interior of a preform and is configured so as to route the sterilizing radiation from the radiation source into the interior of the preform and onto an inner side of the preform.

44. The device as claimed in claim 43, wherein the radiation source is disposed so as to move with the preform.

45. The device as claimed in claim 43, wherein the radiation source is stationary, and further comprising a device that guides the preforms past the radiation source.

46. The device as claimed in claim 43, wherein the radiation source is a UV emitter.

47. The device as claimed in claim 46, wherein the infeeding installation at least in areas is made of a material which conducts UV radiation.

48. The device as claimed in claim 47, wherein the material is a quartz glass.

49. The device as claimed in claim 43, wherein the infeeding installation has an external contour shaped to follow an internal contour of the preform to be sterilized, and the infeeding installation having external dimensions dimensioned so that in a deployed position in the preform a narrow gap remains between the infeeding installation and the preform.

50. The device as claimed in claim 49, wherein the gap is equidistant.

51. The device as claimed in claim 43, wherein the infeeding installation has an internal duct connected with a source for ionized air and/or nitrogen and/or a chemical sterilizing agent, in a flowable aggregate state so that the ionized air and/or nitrogen and/or the chemical sterilizing agent is injectable into the preform.

52. The device as claimed in claim 51, wherein the chemical sterilizing agent is hydrogen peroxide.

53. The device as claimed in claim 43, wherein the infeeding installation configures a stretching rod.

54. The device as claimed in claim 43, wherein the sterilizing installation, in a flow direction of the preforms, is disposed so as to be ahead of the heating section.

55. The device as claimed in claim 54, wherein the sterilizing installation is disposed on an entry star wheel ahead of the heating section and/or on at least one conveying star wheel upstream of the entry star wheel and which has a longer revolving time than the entry star wheel.

56. The device as claimed in claim 43, wherein the infeeding installation is configured for radiating the sterilizing radiation at a tip end in a direction of a closed end of the preform and/or laterally in a direction toward side was of the preform along a substantial length of a region of the infeeding installation deployed into the preform.

57. The device as claimed in claim 43, further comprising a further radiation source disposed and aligned so as to be lateral to a neck area of the preform so that the neck area of the preform is irradiated with sterilizing radiation, wherein the further radiation source is a UV emitter.
